(19) United States
(12) Patent Application Publication
(10) Pub. No.: US 2007/0300173 A1
(43) Pub. Date: Dec. 27, 2007

(54) Apparatus and method for coordinated views of clustered data

(75) Inventor: William A. Woods, Winchester, MA (US)

Correspondence Address: OSHA LIANG L.L.P./SUN, 1221 MCKINNEY, SUITE 2800, HOUSTON, TX, 77010, US

(73) Assignee: Sun Microsystems, Inc., Santa Clara, CA (US)

(21) Appl. No.: 11/474,599

(22) Filed: Jun. 26, 2006

(51) Int. Cl. G06F 3/048

(52) U.S. Cl. 715/769

(57) ABSTRACT

A data display apparatus uses a cluster display window and an item display window that appear simultaneously on a display screen. The cluster display window depicts underlying data elements using clustering icons arranged according to a clustering algorithm. The item display window depicts the data elements using textual information. The two display windows may have interrelated functionality, such that a change to a data element representation in one window changes a representation for the same element in another window. Various means of selecting and manipulating the representations of the data elements in the two windows are also provided.

### FIELD OF THE INVENTION

This invention relates, generally, to the field of displaying data on computer monitor and, more specifically, to the displaying of data clusters in efficient ways.

### BACKGROUND OF THE INVENTION

Data clustering is well known, and a multitude of clustering algorithms and applications exist in the art. Many user interfaces exist for viewing clustered data as distributions of points in a two-dimensional or three-dimensional display, or as networks of nodes connected by edges, where the nodes represent clusters and the edges represent relationships between the clusters. In many of these interfaces, the clusters shown in the display are labeled with some readable name. In some cases, there is a hierarchical organization to the displayed clusters, where each cluster can be expanded to reveal sub-clusters within that cluster. In some of these cases, clusters can be selected as relevant or irrelevant to some task, and reclustering or reorganization may take place in response to such user feedback. The clusters themselves may also be the result of a query whose results are the items being clustered.

While the data being clustered in prior art often has many dimensions in which items can differ, only two such dimensions (or two parameters derived from those dimensions) can be used at any moment for mapping to a two-dimensional cluster display. This can be increased to three dimensions by mapping to a three-dimensional space and rotating that space for projection to a two-dimensional display. In some cases, it may also be possible to generate a three-dimensional display in real three-dimensional space. This leaves most of the dimensions of difference unrepresented in the display, and if a user's interests relate to those dimensions, it may be difficult or impossible to guess how the items of interest might be distributed among the visible cluster nodes in a display. Thus, the user is reduced to having to guess at which cluster might contain desired information, exploring that cluster and, if unsuccessful, trying again with another cluster.

### SUMMARY OF THE INVENTION

In accordance with the present invention, a data display apparatus is provided that displays data elements on a display screen accessible by a data processor having a memory storage device. The data elements each have a plurality of parameters the values of which vary from one element to another. A cluster display module is used that presents the data elements in a cluster format on the display screen, such that graphical cluster icons are displayed, each of which represents one or more of the data elements. An item display module is also used with the invention, and presents the data elements in an item format on the display screen, such that textual information regarding the parameters of the data elements is displayed. The cluster display module and the item display module are controlled by a controller such that the graphical cluster icons and the textual information are viewable on the display screen simultaneously.

In one embodiment, the graphical cluster icons are displayed in a first display window on the display screen, and the textual information is displayed in a second display window on the display screen that is different from the first window. The first display window and the second display window may be displayed adjacent to each other simultaneously on the display screen. The data processor may be made accessible to a user input device, such as a graphical user interface that displays a cursor on the display screen. The input device may be used by a user to manipulate the cluster display module and the item display module so as to modify the manner in which the data elements are displayed on the display screen. In addition, the manipulation of a part of either the cluster display or the item display that relates to a particular data element may result in a corresponding manipulation of a part of the other display that is associated with the same data element. Thus, if a user uses a graphical user interface to highlight a component of the cluster display window that pertains to a given data element, this may cause text in the item display that relates to that same data element to also be highlighted. Similarly, the selection of a cluster in the cluster display window using a user input device may result in the exclusion of data elements from the item display window that are associated with that cluster or, alternatively, the exclusion from the item display window of data elements that are not associated with that cluster.

Visual comparison and coordination of information presented in the two displays is facilitated by the use of common distinguishing features. Such features might include a visually salient color, icon, or label that is visible in both displays. The use of a common distinguishing feature with components of the cluster display and the item display that share a common data element allows a user to visually identify which items in the item display are associated with which categories in the cluster display and vice versa.

The invention may use any of a number of different known means for generating the desired display windows. In one possible configuration, a digital computer, such as a self-contained personal computer or workstation linked to a central server, is used as a host for the application, and has a display screen for use with the invention. An item store may be created in the memory of the computer, and the data and parameters of the items of interest stored therein. This data is then used by desired clustering algorithms to organize the items in a clustering arrangement, and these clusters are stored in a cluster store. The item display module uses the items in the item store to generate the item display, and the invention may include functions for enabling user manipulation of this display, such as sorting, filtering, highlighting and scrolling. The item display itself may make use of a memory space into which the item display window is mapped. The cluster display module uses the clusters in the cluster store to generate the cluster display, and the invention may include functions for enabling user manipulation of this display, such as rotating, zooming, filtering, and projecting. The cluster display itself may make use of a memory space into which the cluster display window is mapped.

Any of a number of different variations may be incorporated into the invention. For example, mutual highlighting of clusters and text items in the cluster display and item display, respectively, may be enabled to allow a user to correlate the two representations used for a data element. A means of identifying or excluding data elements by selecting clusters or items that are “good” or “bad” using an input device may allow a user to narrow a search for particular data elements. The textual information of the item display window may be presented in a table format, and the data elements listed may be sortable by different parameters represented by columns or rows of the table. Some other features may include an inset window that appears when a user identifies a particular cluster in the cluster display with an input device, the inset window providing textual information regarding that cluster. A similar inset box may also appear if a cluster identified with the input device is representative of multiple clusters that overlap in a given portion of the cluster display window, the inset window providing information regarding each of the underlying clusters. The system may also allow the simultaneous use of multiple cluster windows, each of which displays the clusters according to a different algorithm or set of rules, and the cluster window or windows and item window or windows may overlap with one another on the display screen, with a user being able to select the window that is shown in its entirety using an input device. For overlapping cluster display windows, it may also be possible to show the clusters from both windows in the same overlapping region, thereby allowing a user to intentionally overlap the cluster displays for a quick visual comparison of the relative orientation of the clusters of the different cluster display windows.

### BRIEF DESCRIPTION OF THE DRAWINGS

The above and further advantages of the invention may be better understood by referring to the following description in conjunction with the accompanying drawings in which:

FIG. 1 is a schematic depiction of a cluster display window and an item display window according to the invention that are shown simultaneously on a display screen;

FIG. 2 is a schematic depiction of a possible control hierarchy of the present invention;

FIG. 3 is a schematic depiction like that of FIG. 1 in which there is corresponding highlighting of associated components in the two display windows when an input device is used to select an element of the item display window;

FIG. 4 is a schematic depiction like that of FIG. 1 in which there is a corresponding highlighting of associated components in the two display windows when an input device is used to select an element of the cluster display window;

FIG. 5 is a schematic depiction of a cluster display window according to the present invention for which a “good/bad” selection means is provided to the user;

FIG. 6 is a schematic depiction of an item display window according to the present invention for which textual information is provided in a table format that may be sorted by different parameters;

FIG. 7 is a schematic depiction of cluster display window according to the present invention for which an inset window appears in response to a user input, and provides summary information regarding a particular cluster;

FIG. 8 is a schematic depiction of a cluster display window according to the present invention for which an inset window appears in response to a user input, and provides information regarding multiple clusters that may be overlapping in the display window;

FIG. 9 is a schematic depiction of a display screen on which there are multiple cluster display windows and an item display window according to the present invention displayed simultaneously;

FIG. 10 is a schematic depiction of a display screen on which there are multiple display windows according to the present invention that are overlapping on the display screen; and

FIG. 11 is a schematic depiction of multiple cluster display windows according to the present invention that are overlapping with each other in a way that allows the clusters of both windows to be viewed in the overlapping space of the windows.

### DETAILED DESCRIPTION

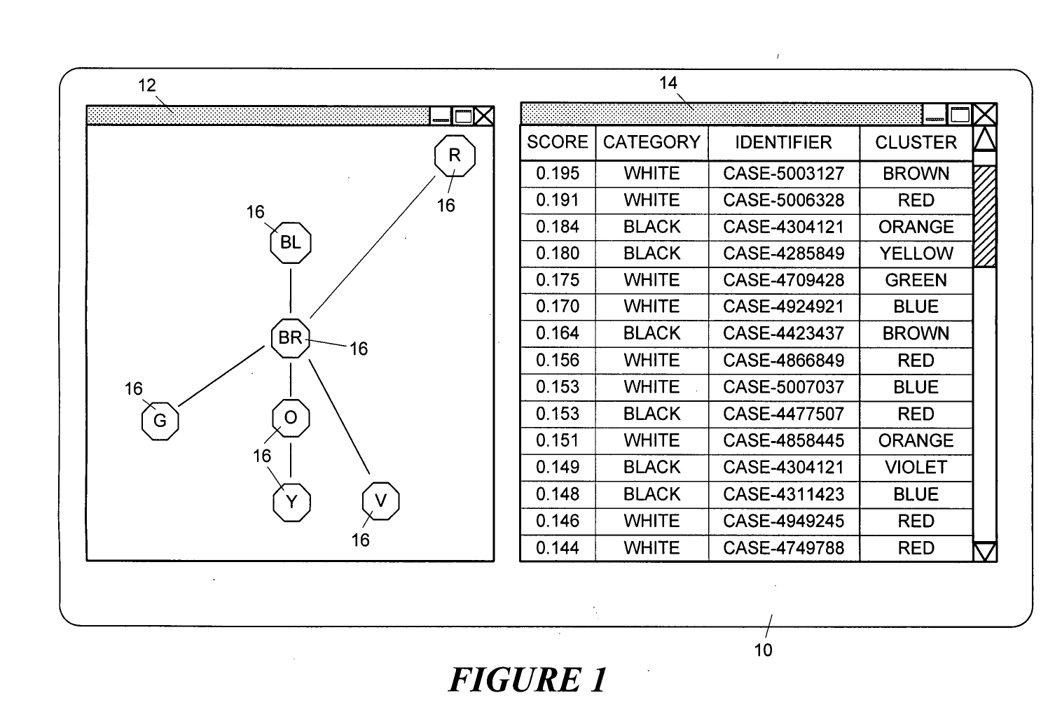

Shown in FIG. 1 is a graphical representation of the display screen of a computer monitor. Displayed on the screen are two windows, a cluster window 12 and an item window 14. The cluster window is similar to prior art cluster displays in that it depicts a plurality of icons, each of which represents a different cluster node. In this example, there are seven nodes displayed, although those skilled in the art will understand that there may be more or fewer. In addition, the nodes shown in cluster window 12 are each a different color for identification purposes. The colors are represented in the figure by labels on the nodes that have the following correlation to the node color: G for green; Bl for blue; Br for Brown; O for orange; Y for yellow; R for red; and V for violet. In an actual display, the labels would not necessarily be present, as the nodes could be identified by color alone on a color monitor.

The nodes 16 represent different categories of data and, in addition to being labeled with colors, the nodes 16 are positioned relative to one another according to some criteria. These parameters of the display are not unlike those used in conventional clustering displays. However, in the display 10 of FIG. 1, the cluster window 12 is joined by item window 14, which provides additional user information.

The item window 14 shows a list of the items that make up the cluster display. The items in the list are labeled with the colors of the clusters to which they correspond, so that an easy visual correlation may be made. The list includes additional information that may be of interest to the user, so that the list allows the user more insight into the content of the cluster display. The specific information being displayed depends on the information content of the cluster display, and the particular application in question. In the example, the items are shown ordered by decreasing values of a score parameter and displayed with a characterization of their membership in two predefined categories (“black” and “white”). These scores and these categories are illustrative of the kinds of information one may have about the items being clustered.

As shown in FIG. 1, the items in the item window are marked with the color of the clusters into which they have been grouped. In this example, no item is in more than one cluster, although those skilled in the art will recognize that membership in multiple clusters may exist. In such a case, more than one color may be associated with a single item. It will also be recognized that the use of color is just one possible choice of an easily identifiable label, and different types of labels may be used instead.

The presence of the item window in addition to the cluster window makes the cluster display useful in a way that is lacking when using a cluster display alone. In particular, a user can scan the items, noticing the cluster colors, and obtain an intuitive feel for how the clusters are distributed with respect to the scores, or with respect to the categories of interest. The example of FIG. 1 might be interpreted by a user as follows.

From the cluster window 12, a user can see that the red cluster is an extreme case based on its location within the display space of the window. That is, the red cluster differs from the other clusters more than they do from one another. It can also be intuitively determined that the brown cluster is a central cluster around which the others appear to be grouped. However, the cluster display itself provides no information about why this might be so. Without further examining the clusters themselves, there is little additional information that may be gleaned from viewing the cluster window 12.

From the item window 14, a user is provided with additional information regarding the clusters. The items are tagged with the cluster colors, and it can be seen that there is a relatively large number of items associated with the red cluster, as the red label occurs frequently in the list. Moreover, the “red” items are distributed throughout the score space, and are associated frequently with both the “black” and “white” categories. It can also be seen that the “brown” items are also distributed throughout the score space and are also associated with both “black” and “white,” but that the brown items occur less frequently overall.

Switching attention back and forth between the two windows, one may notice that the distance of clusters from the origin (i.e., the lower left hand corner) of the cluster window 12 appears to be correlated with the frequency with which certain items associated with a particular cluster appear (based on those items shown in the figure). In addition, it can be seen that the categories (as represented by the clusters) close to a diagonal from the origin to the upper right hand corner of the window are associated with both the black and the white categories. It may also be noted that the yellow and violet clusters contain only black cases, and that the blue cluster has a higher concentration of white cases. None of these insights would be possible with just the cluster display alone, and they would not be nearly as easy to detect from just a linear list alone, even if that list includes color tags.

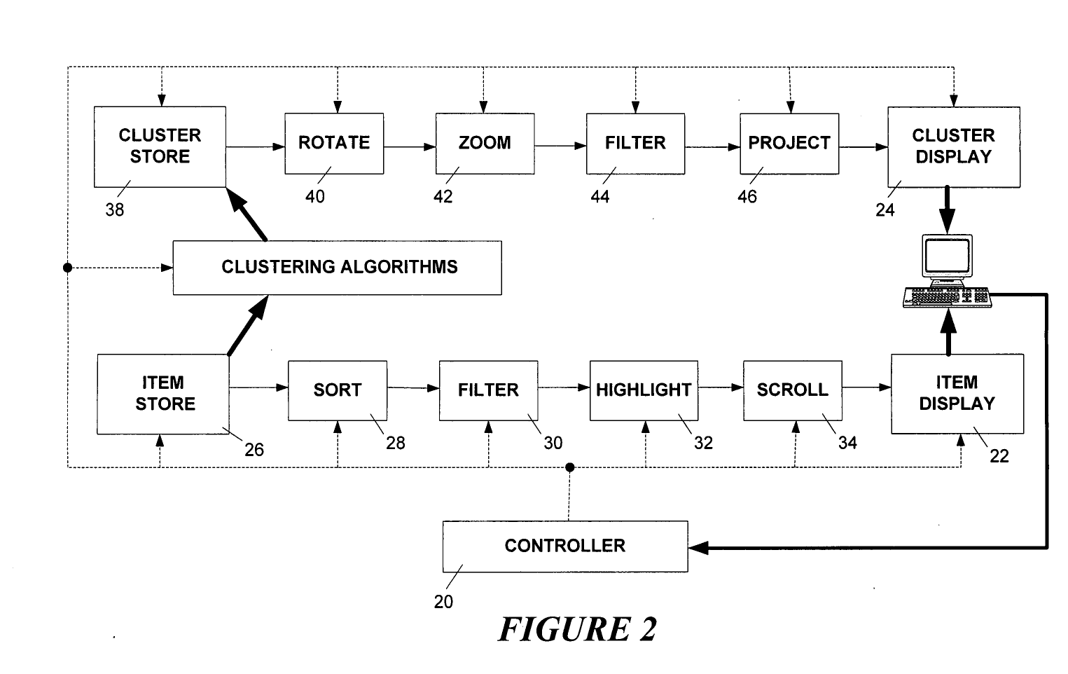

Implementation of the invention may make use of traditional display control techniques on a conventional computer workstation. The system itself may be embodied in a software application that enables the display functions described herein. FIG. 2 shows a block diagram of a possible arrangement for controlling a display as shown in FIG. 1. Shown in FIG. 2 is a controller 20 that oversees the cluster display application. The displayed information is represented in memory by two different components, the item display 22 and the cluster display 24. The representations in both the item display and the cluster display are based on the items themselves, which are stored in item store 26. To create the item display, the items may be processed by any one of a number of different functions, although these functions are not necessary to operation of the invention. A sorting function 28 arranges the items according to some chosen parameter. A filter function 30 may restrict the items directed to the display according to one or more parameters. A highlight function 32 may be used to give unique display attributes to one or more of the items. And a scroll function 34 may be used to scroll up and down in the display list. The items conditioned by these functions are then assembled in the item display, from which the item window 14 of FIG. 1 is generated.

The item store 26 shown in FIG. 2 also supplies the item data to one or more clustering algorithms 36 used by the application. These may be any of a number of conventional clustering algorithms, and the detail of their operation is known in the art, and will not be repeated herein. Once the clusters are assembled, they are stored in cluster store 38, which is the source of the cluster data used by the cluster display 24. The cluster store data is then passed through any of a number of different functions that modify the way the clusters are presented in the cluster display 24, and therefore how they appear on the display screen. A rotate function 40 may be used to change the rotational orientation of the clusters. A zoom function 42 changes the apparent size of clusters on the display. A filter function 44 may restrict the items directed to the display according to one or more parameters. And a projection function 46 may be used to project a portion of the cluster parameter space onto the visible portion of the cluster display. The cluster data conditioned by these functions are then assembled in the item display, from which the cluster window 12 of FIG. 1 is generated.

As shown in FIG. 2, the controller oversees all of the other functions in the system and coordinates the processing. The controller is part of a software application that runs on the workstation and operates according to user inputs provided via the workstation input devices. Those skilled in the art will recognize that the controller and other elements could also run on a remote server accessed by a workstation or a display terminal. A user running the application can manipulate how the data is organized and displayed in the item and display windows. The specifics of how to implement these functions will be apparent to one skilled in the art. However, a number of variations may be incorporated into the features of the application. Some of these are discussed further below.

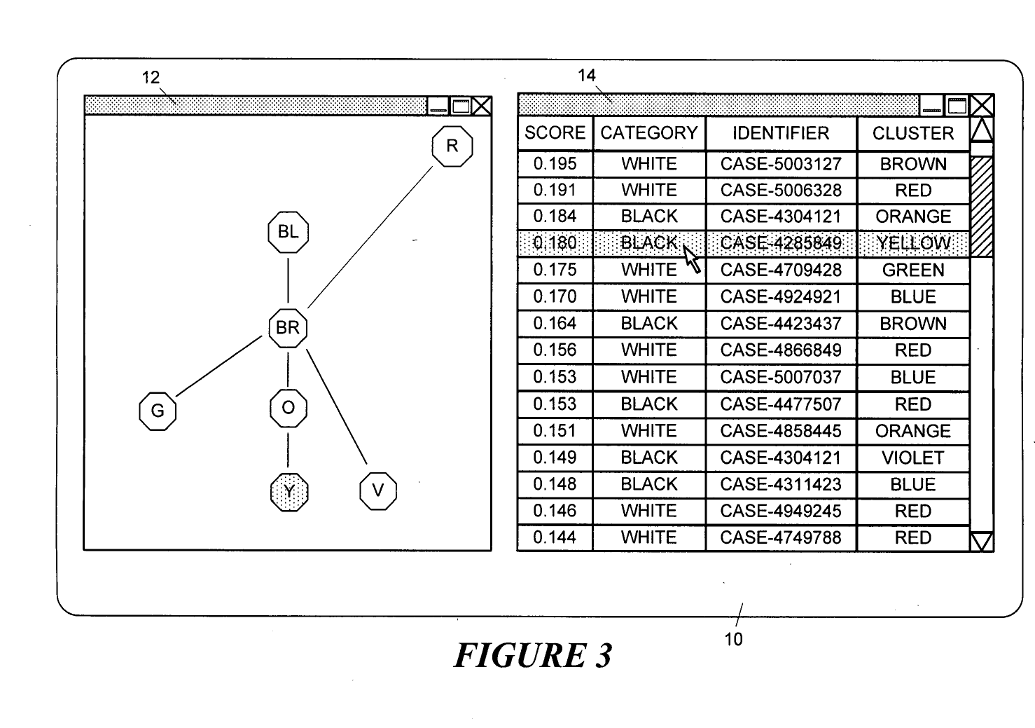

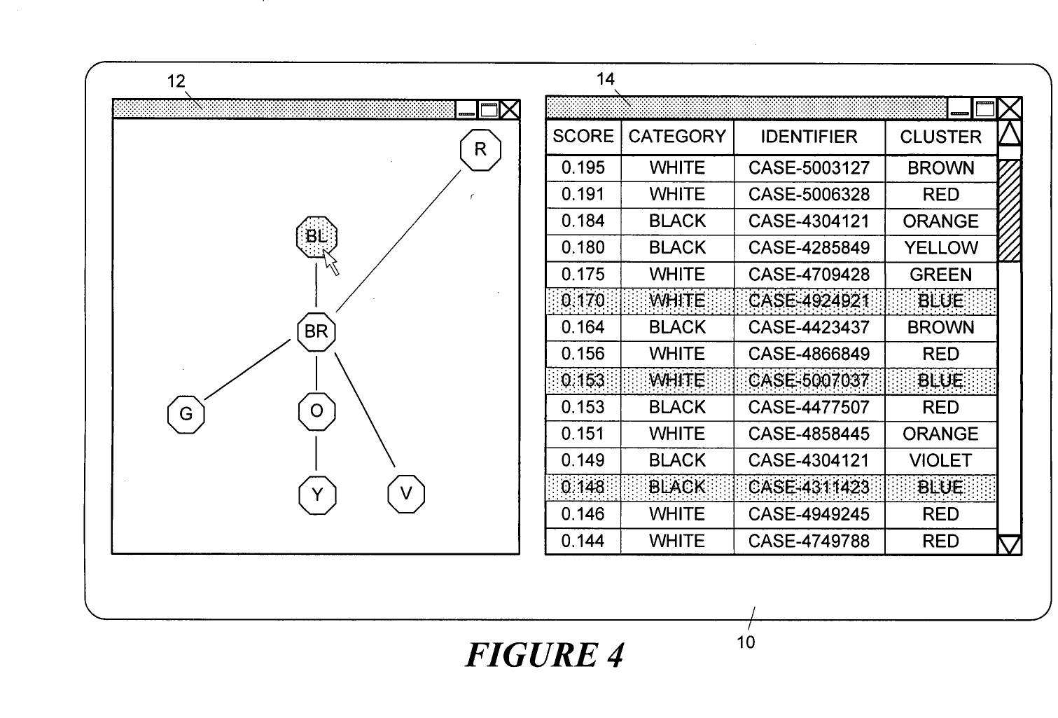

It may be desirable to have a visual correlation between items selected in one of the display windows using a graphical user interface and corresponding items in the other display window. Shown in FIG. 3 is an example of this, where a cursor has been used to select an item in the item display window 14. This selection results in the highlighting of the selected item in the item list. Since the example selection is of an item that is associated with the yellow cluster, its selection also results in a highlighting of the yellow cluster in the cluster display window 12. This allows the user to make an easy visual correlation between the item selected and the cluster display. The selection function may also be reciprocal, such that the selection of a cluster in the cluster display causes the highlighting of any items in the item display that are associated with that cluster. An example of this is shown in FIG. 4.

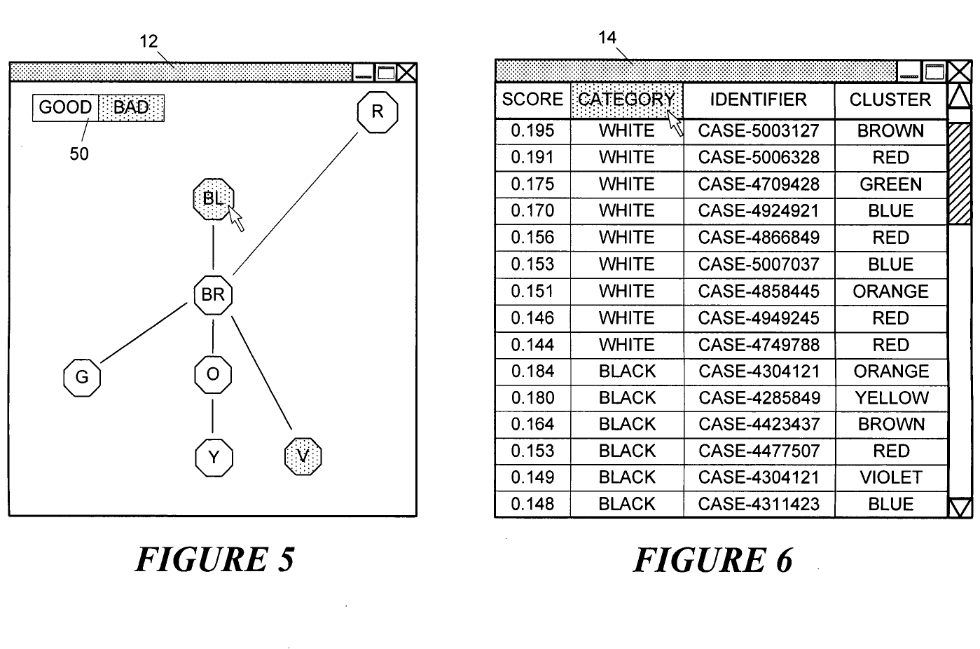

In another variation, the graphical user interface may be used to make choices in the cluster display for identifying clusters for narrowing a search for items of interest. Shown in FIG. 5 is a cluster display window with a selection icon 50 labeled “GOOD/BAD” in an unoccupied corner of the window. The selection icon 50 includes two regions that are selectable using a graphical user interface, and act as toggles for either the “GOOD” or the “BAD” choices. Once selected, the choice that has been toggled to an active position may be shaded, or otherwise indicated, in the display, as is the case for the “BAD” choice shown in FIG. 5. Subsequent selections of clusters will then be identified with the selected choice, and may also be marked, as is shown for the blue cluster and the violet cluster of the figure. When a cluster is selected to be identified with a particular choice, corresponding changes may be made in the item display. So, for example, selection of the blue cluster icon in the cluster display may cause all of the items in the item display that are associated with the blue cluster to be shaded, or to be omitted altogether from the display. Similarly, if the “GOOD” choice is selected, items corresponding to the clusters identified with this choice may be highlighted, or isolated by the shading or omission of the items corresponding to the other clusters. Those skilled in the art will recognize that there are many other ways to use cluster highlighting to affect item display.

FIG. 6 shows a variation of the invention in which the information in the item display is sortable by the user. The information in the item display is organized in columns, with each column having an identifying label at the top. In this example, the columns are labeled “SCORE”, “CATEGORY”, “IDENTIFIER” AND “CLUSTER.” In this example, the regions of the item display where these labels are displayed may be selectable using a user interface to cause the sorting of the information by these categories. Thus, a selection of the label “CATEGORY” by the user, as is shown in the figure, causes the items listed below in rows to be arranged in the display according to this category. In this case, the selection causes all of the items falling into the “WHITE” category to be listed first, with those in the “BLACK” category being listed thereafter. A second selection on the same region could be used to rearrange the items so that the “BLACK” category is listed first. Similarly, numerical data, such as that found in the “SCORE” category might be listed in either ascending or descending order, with the particular order being changed by user selection of the region bearing the “SCORE” label. Such sorting techniques are known from other applications, and those techniques may be used herein as well.

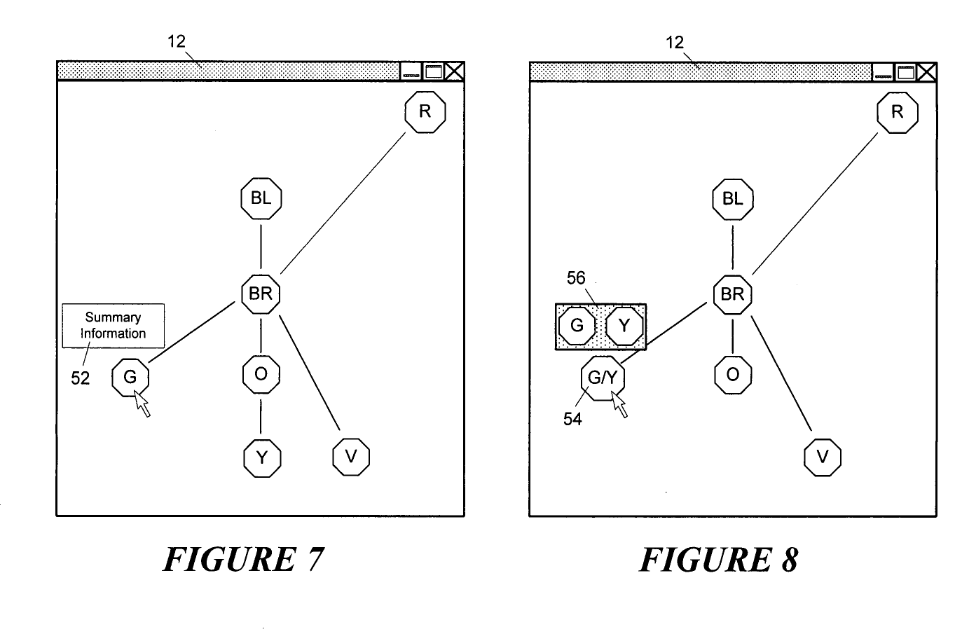

Some other variations of the invention include different means of displaying relevant information in the display windows. In FIG. 7, an example is shown in which the movement of a cursor controlled by the user into the region of the cluster display window occupied by a cluster results in the generation of a small inset window 52 in which is contained information regarding the cluster. In the figure, the text shown in the inset window is “Summary Information,” but those skilled in the art will understand that this is just a representation for the textual information that would actually be shown.

In FIG. 8, a cluster display window is shown for which two clusters occupy the same region of the window. In such a case, a cluster 54 shown in that region may be displayed in a way that makes the sharing of the space apparent. In this figure, the label “G/Y” is shown on the cluster to represent that both the green cluster and the yellow cluster are co-located. However, in practice, the cluster may actually be colored with both yellow and green to convey this to the user. In this example, the movement of a cursor controlled by the user into the region of the cluster display window occupied by this cluster results in the generation of an inset window 56, in which may be displayed an indication of the clusters that are represented by the combined cluster 54.

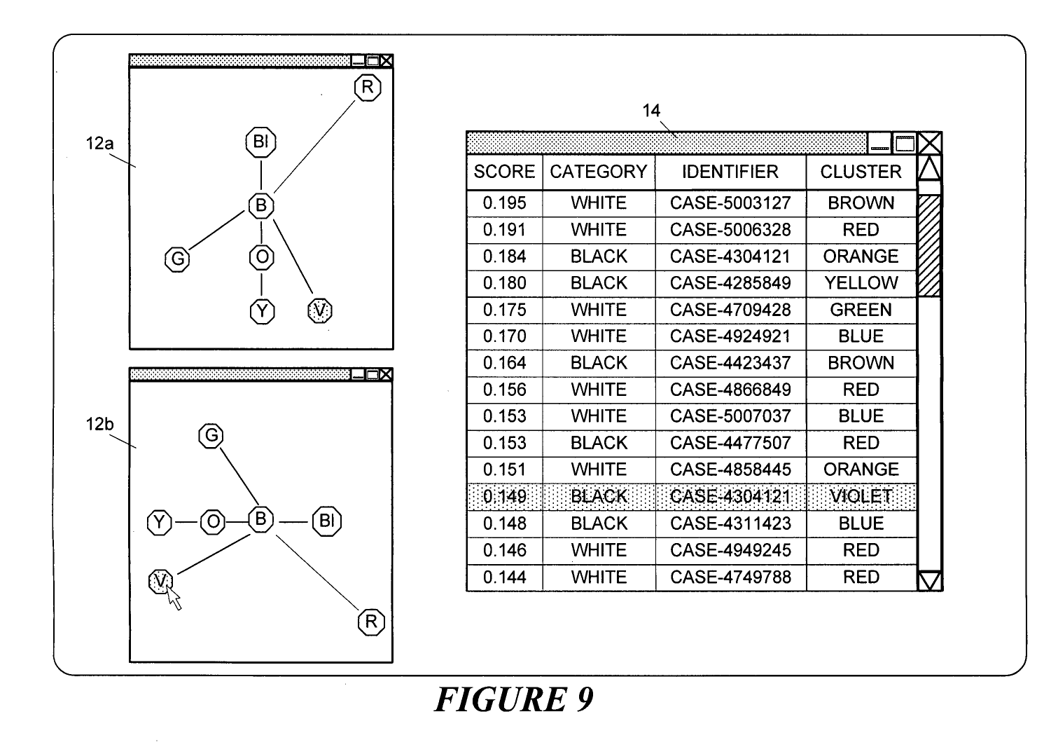

FIG. 9 is an example of one variation in which multiple cluster display windows 12a and 12b are shown, along with item display window 14. Both cluster display windows are generated by the same cluster display module, and use the same item data to generate two different cluster displays according to different clustering rules. The interaction of a user with the different windows may be connected, such that selection of a cluster in cluster window 12b to highlight that cluster, results in the highlighting of a corresponding cluster in the cluster window 12a, and may also resulting in highlighting of any item data in the item display window 14 that corresponds to the selected cluster.

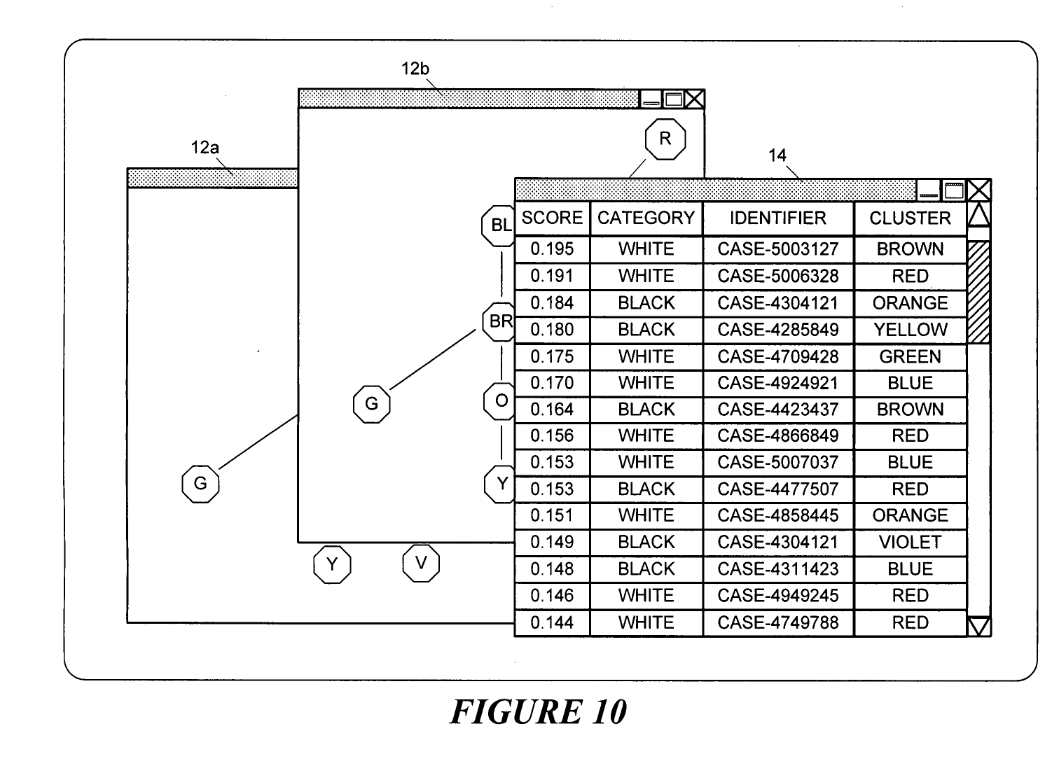

FIG. 10 shows how multiple windows may be overlapped on a display screen. As is well know in programming techniques using display windows, the multiple display windows may be interactive so that the selection of one window using a user input device results in that window being displayed to the exclusion of any overlapping portion of another window. Similarly, windows may be moved on the display screen using a graphical user interface, as well as minimized, opened and closed.

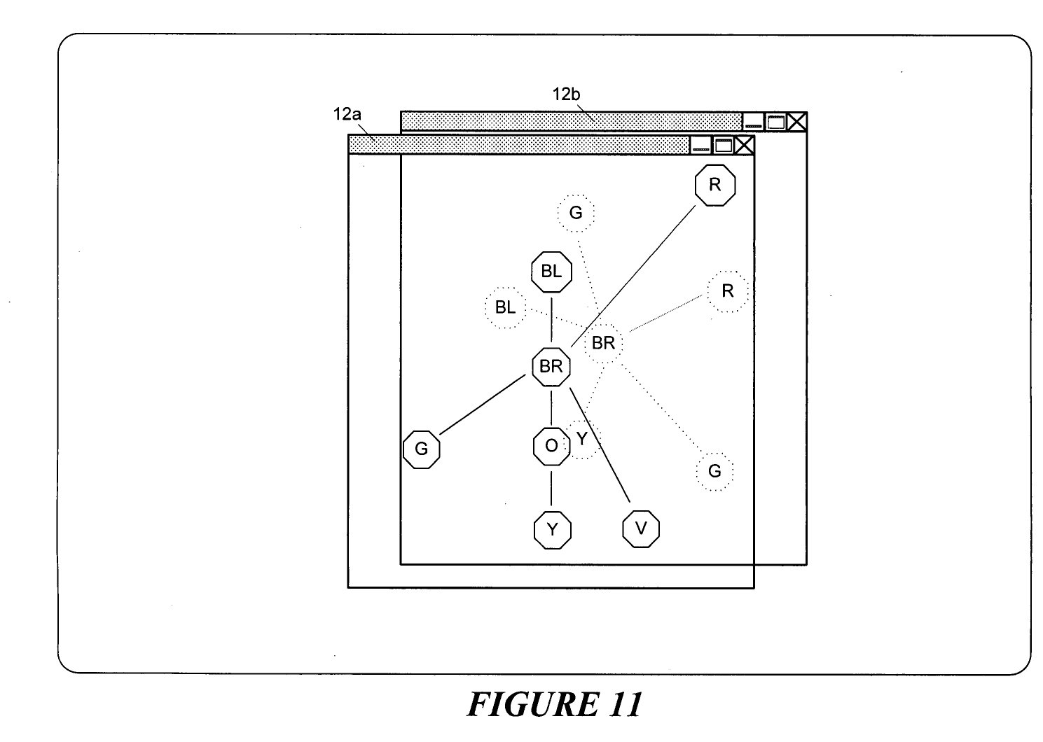

FIG. 11 depicts another variation of the present invention in which multiple display windows may be viewed when overlapping one another. In the example shown, a cluster display window 12a is shown “in front of” a second cluster display window 12b on the display screen. While in another variation this might result in none of the overlapping portion of window 12b being viewable on the display screen, in the FIG. 11 example, the clusters of cluster display window 12b that overlap with display window 12a are still visible, albeit in broken lines. This ability to simultaneously view two superimposed windows allows a user to do a simple visual comparison of the cluster arrangement of two different cluster windows. The use of broken lines for the overlapping clusters of window 12b distinguishes them from the clusters of window 12a. However, those skilled in the art will recognize that other distinguishing characteristics may be used instead, or no distinguishing characteristics at all.

Those skilled in the art will recognize that the invention is not limited to embodiments related to clustered data. Indeed, the invention can be applied to any graphical display of data in a spatial layout paired with an item display of the individual data. Examples might include a display of geographical distribution of automobile accidents or other events, a time versus income level display of drunken driving arrests, or any scatter plot of items with respect to feature values. Numerous other possibilities also exist.

While the invention has been shown and described with reference to a preferred embodiment thereof, it will be recognized by those skilled in the art that various changes in form and detail may be made herein without departing from the spirit and scope of the invention as defined by the appended claims.

What is claimed is:

1. A data display apparatus for displaying data elements on a display screen accessible by a data processor having a memory storage device, the data elements each having a plurality of parameters the values of which vary from one element to another, the apparatus comprising:
a cluster display module that presents the data elements in a cluster display on the display screen, such that graphical cluster icons, each representative of one or more of the data elements, are displayed with a spatial relationship to one another that is dependent on the values of said parameters;
an item display module that presents the data elements in an item display on the display screen, such that textual information regarding the parameters of data elements is displayed; and
a controller that controls the cluster display module and the item display module such that the graphical cluster icons and the textual information are viewable on the display screen simultaneously in such a way as to allow a user to visually correlate clusters in the cluster display with corresponding textual information in the item display.

2. An apparatus according to claim 1 wherein the cluster display module and the item display module receive signals from a user input device to select components of the cluster display and components of the item display, and wherein selection of a component of one of the cluster display and the item display modifies a manner in which a corresponding component is displayed in the other display.

3. An apparatus according to claim 2 wherein selection of a cluster in the cluster display results in highlighting of textual information in the item display that corresponds to a data element associated with the highlighted cluster.

4. An apparatus according to claim 2 wherein selection of a cluster in the cluster display may be used to selectively exclude textual information regarding data elements associated with that cluster from being displayed by the item display module.

5. An apparatus according to claim 1 wherein common distinguishing display features are used to coordinate components in the cluster display and the item display such that a distinguishing display feature applied to a first cluster in the cluster display is also applied to an item in the item display that corresponds to a data element associated with the first cluster.

6. An apparatus according to claim 1 wherein the cluster display module uses data stored by the item display module to generate the graphical cluster icons.

7. A method of displaying data elements on a display screen accessible by a data processor having a memory storage device, the data elements each having a plurality of parameters the values of which vary from one element to another, the method comprising:
(a) presenting the data elements in a cluster display on the display screen, such that graphical cluster icons, each representative of one or more of the data elements, are displayed with a spatial relationship to one another that is dependent on the values of said parameters;
(b) presenting the data elements in an item display on the display screen, such that textual information regarding the parameters of data elements is displayed; and
(c) controlling the cluster display and the item display such that the graphical cluster icons and the textual information are viewable on the display screen simultaneously in such a way as to allow a user to visually correlate clusters in the cluster display with corresponding textual information in the item display.

8. A method according to claim 7 further comprising:
(d) changing the cluster display and the item display in response to signals generated by a user input device to select components of the cluster display and the item display; and
(e) in response to a selection of a component of one of the cluster display and the item display, modifying a manner in which a corresponding component is displayed in the other display.

9. A method according to claim 8 wherein step (c) comprises:
(c1) in response to a selection of a cluster in the cluster display, highlighting an item in the item display that corresponds to a data element associated with the highlighted cluster.

10. A method according to claim 8 step (c) further comprises:
(c2) in response to a selection of a cluster in the cluster display, selectively preventing textual information regarding data elements associated with that cluster from being displayed by the item display module.

11. A method according to claim 7 wherein common distinguishing display features are used to coordinate components in the cluster display and the item display such that a distinguishing display feature applied to a first cluster in the cluster display is also applied to an item in the item display that corresponds to a data element associated with the first cluster.

12. A method according to claim 7 wherein step (a) comprises using data elements in the item display to display the graphical cluster icons.

13. A data display apparatus for displaying data elements on a display screen accessible by a data processor having a memory storage device, the data elements each having a plurality of parameters the values of which vary from one element to another, the apparatus comprising:
means for presenting the data elements in a cluster display on the display screen, such that graphical cluster icons, each representative of one or more of the data elements, are displayed with a spatial relationship to one another that is dependent on the values of said parameters;
means for presenting the data elements in an item display on the display screen, such that textual information regarding the parameters of data elements is displayed; and
means for controlling the cluster display and the item display such that the graphical cluster icons and the textual information are viewable on the display screen simultaneously in such a way as to allow a user to visually correlate clusters in the cluster display with textual information in the item display.

14. An apparatus according to claim 13 wherein the cluster display and the item display receive signals from a user input device to select components of the cluster display and the item display, and wherein selection of a component of one of the cluster display and the item display modifies a manner in which a corresponding component is displayed in the other display.

15. An apparatus according to claim 14 wherein selection of a cluster in the cluster display results in highlighting of an item in the item display that corresponds to a data element associated with the highlighted cluster.

16. An apparatus according to claim 14 wherein selection of a cluster in the cluster display may be used to selectively exclude textual information regarding data elements associated with that cluster from being displayed in the item display.

17. An apparatus according to claim 13 wherein common distinguishing display features are used to coordinate components in the cluster display and the item display such that a distinguishing display feature applied to a first cluster in the cluster display is also applied to an item in the item display that corresponds to a data element associated with the first cluster.

18. An apparatus according to claim 13 wherein the means for presenting the data elements in a cluster display format uses data stored by the means for presenting the data elements in an item display format to generate the graphical cluster icons.
